(19) United States
(12) Patent Application Publication
(10) Pub. No.: US 2011/0270771 A1
(43) Pub. Date: Nov. 3, 2011

(54) System and method for a flexible management of the escalation of support for devices

(75) Inventors: Jean-Marc Coursimault, Revel (FR); Maria Antonietta Grasso, Grenoble (FR); Frederic Roulland, Le Versoud (FR); Stefania Castellani, Meylan (FR)

(73) Assignee: Xerox Corporation, Norwalk, CT (US)

(21) Appl. No.: 12/772,692

(22) Filed: May 3, 2010

(51) Int. Cl. G06Q 10/00

(52) U.S. Cl. 705/304

(57) ABSTRACT

A system and method are disclosed for determining when to escalate from one support level to a higher support level in assisting a user resolve a problem with a device. The method includes storing information on past users' interactions with a self help server during prior self help sessions, the self help server providing a first remote support level for troubleshooting a problem with a device. Information is stored on a current user's interactions with the self help server during a current self help session for troubleshooting the current user's problem with a device. A determination of when to provide for escalation to a higher remote support level for troubleshooting the current user's problem with the device is based on the stored information on the past users' interactions and the current user's interactions.

### BACKGROUND

The exemplary embodiment relates to provision of support for users in resolving problems with electromechanical devices, such as printers. In particular, it relates to a system and method for advancement to a higher level of support based on stored interactions of the user with the device or remote support system.

Office printers and multifunction devices (MFDs) with printing capabilities are typically supplied to customers with a service contract which provides various levels of assistance for diagnosing and solving problems with the device, for example in the event of a malfunctioning of the device. Typical problems arise because of machine faults, such as paper jams, or poor print quality on the output documents, in the case of a printer. The first level of assistance may be a self-help level. For some printers, the self-help assistance may be provided by built-in diagnostic tools on the device or may be in the form of a user manual or diagrams on the user interface showing possible locations of printer jams and out-of-supply notices. For printers linked to a personal computer, the install disk of the printer may include diagnostics in the form of a utility program to be run on the user's personal computer. Additionally, users of the device may have access to an on-line support system, such as a knowledge base, which provides solutions for known problems with the device.

If the self-help assistance fails to resolve the problem, the user may enlist the help of an operator in a remote call center, who guides the user in diagnosing and solving problems with the device. In the event that neither the self-help or call center assistance fails to resolve the problem, the user may call out a service engineer to the site of the printer.

To provide cost-effective and timely service to the customer, the service provider encourages the user to utilize the self-help resources followed by use of the call center remote troubleshooting. These two assistance levels may be seen as incremental, the second one being an escalation of the first. However, both levels of service rely heavily on the willingness of the customer to participate in the troubleshooting activity. Some customers are reticent to use the self help options if they have a problem using it. Further, when a user has spent considerable time using the self-help resources without success, he may be unwilling to engage in a remote troubleshooting session taking up more of his time. The in-person visit of a service engineer, while often the most likely option to lead to a successful resolution of the problem, is generally the most costly to the service provider. The customer may also be inconvenienced by the delay in waiting for the service visit.

The exemplary system and method provide a mechanism for escalating the assistance being provided to a higher level which encourages the appropriate usage of assistance resources by the customer.

### INCORPORATION BY REFERENCE

The following references, the disclosures of which are incorporated in their entireties by reference, are mentioned:

U.S. Pat. No. 5,490,089 issued Feb. 6, 1996, entitled INTERACTIVE USER SUPPORT SYSTEM AND METHOD USING SENSORS AND MACHINE KNOWLEDGE, by Smith, et al., discloses an interactive user support system for a document processing system or an image producing device which controls the operation of the machine using an internally stored knowledge base derived from information and rules provided by experts in the field. A plurality of sensors monitors the operation of the machine and a variety of user actions. If the system determines that the user needs help, by comparing the operation of the machine with the information and rules in the knowledge base, the system will interrupt the user and offer or provide assistance. If the user is performing proper steps to correct a problem or perform a specific job, the system will not interrupt the user.

U.S. Pub. No. 2007/0220365, published Sep. 20, 2007 (U.S. Pat. No. 7,647,534), entitled METHOD FOR AVOIDING REPETITION OF USER ACTIONS BY USING PAST USERS' EXPERIENCES, by Castellani, et al., discloses a method for assisting a user to connect a problem with a device, such as a printer includes extracting, from records comprising user actions on the device, string of user actions on the device. The string of user action is compared with at least one predetermined sequence of user actions for correction of predefined problem with the device. Based on the comparison, an evaluation is made as to whether at least one prior user has attempted the predetermined sequence and, if so, a procedure is implemented to avoid a user repeating the prior attempt.

U.S. Pub. No. 2007/0279668, published Dec. 6, 2007, entitled NOTIFICATION ESCALATION IN PRINTING SYSTEMS, by Czyszczewski, et al., discloses a method and system for sensing an intervention state of a printing system and defining conditions for notification to one or more recipients of intervention states of the printing system. The time delay for transmitting escalated intervention notification message may be dynamically determined in accordance with present operating parameters of the printing system.

U.S. Pub. No. 2006/0197973, published Sep. 7, 2006, entitled BI-DIRECTIONAL REMOTE VISUALIZATION FOR SUPPORTING COLLABORATIVE MACHINE TROUBLESHOOTING, by Castellani, et al., discloses a communication system and apparatus for a xerographic imaging system for enhanced collaborative communication between the machine user and the remote troubleshooting advisor. The machine includes an imager for showing a selected virtual representation of the machine including an image of the machine illustrating an area of the machine having the troubleshooting need. A communication link exists between the user and the advisor and comprises a bi-directional visualization of a selected virtual representation synchronously displayed to the user and the advisor via respective imagers. An image adjuster is operated by the expert for selective adjustment of the virtual representation to suggest a section of the area of the machine wherein action by the machine user may resolve the troubleshooting need. The corrective action is identified to the user by identifying a difference between the actual machine state and the shared virtual representation. The visual indicators may direct the user to a particular location and percussion centers on the machine identify a particular tapping location by the user to verify position identification to the troubleshooting expert.

U.S. Pub. No. 2008/0294423, published Nov. 27, 2008, entitled INFORMING TROUBLESHOOTING SESSIONS WITH DEVICE DATA, by Castellani, et al., discloses a method for troubleshooting a problem with a device which includes acquiring device data for the device, receiving a user's query concerning the device in a natural language, presenting possible refinements to at least a portion of the user's query for defining a problem statement, and presenting candidate solutions that are associated with the defined problem statement in a knowledge base. These latter steps can be informed by device data that is linked through a diagnostic model of the device to at least one of the problem statements and candidate solutions.

U.S. Pub. No. 2009/0292700, published Nov. 26, 2009, entitled SYSTEM AND METHOD FOR SEMI-AUTOMATIC CREATION AND MAINTENANCE OF QUERY EXPANSION RULES, by Stefania Castellani; et al. discloses a system and method which enable semi-automated generation of query expansion rules for searching a knowledge base, based on records of prior user interactions.

U.S. Pub. No. 2009/0094091, published Apr. 9, 2009, entitled SERVICE CALL DATA SELECTION AND DELIVERY METHOD AND SYSTEM, by Thieret, et al., discloses a method of dispatching a service call for document production device. A dispatching server receives a communication requesting service on the device. The communication includes a unique identifier corresponding to that device. The dispatching server accesses operational history data for the device to retrieve service data and sends a service order message to a customer service representative mobile communication device. The message includes a location identifier and operator contact information for the device, as well as the service data.

U.S. Pat. No. 7,565,338, issued Jul. 21, 2009, entitled METHOD AND SYSTEM FOR SHARING KNOWLEDGE, by Beniaminy, et al., discloses a method for providing technical support via a network. The method involves providing a database which contains searchable technical support information which is remotely accessible and divided into a plurality of support sessions. When the database is accessed for technical support, the method performs an electronic serial dialogue between the database and a user. If no solution to the failure is obtained at the end of the electronic serial dialogue, the method immediately transfers a display of the electronic serial dialogue so far conducted to a selected expert.

U.S. Pat. No. 6,959,263, issued Oct. 25, 2005, entitled INTERACTIVE DIAGNOSTIC SYSTEM AND METHOD DRIVEN BY EXPERT SYSTEM, by Wilson, et al., discloses a system for troubleshooting of networked electronic devices. An input receives verbal or text commands from an operator to notify the system of a fault in the networked electronic devices. An inference engine inputs a fact from the command to a knowledge base and applies rules from the knowledge base which are triggered by the fact in conjunction with a plurality of previously asserted facts contained in the knowledge base. The rules may require the inference engine to send commands to peripheral devices for gathering data about the networked electronic devices. Responses in turn trigger the inference engine to input new facts into the knowledge base, which may trigger new rules to be executed by the inference engine to troubleshoot the networked electronic devices.

U.S. Pat. No. 6,393,490, issued May 21, 2002, entitled METHOD AND SYSTEM FOR A PROGRAMMATIC FEEDBACK PROCESS FOR END-USER SUPPORT, by Stiles, et al., discloses a method for supporting the end-user of a software application program. The user is provided with the capability of communicating directly with the application program vendor and/or developer to request enhancement, provide comments, report defects and/or to ask questions. This provides the developer of an application program such critical information as usage of program or document information, defects, and user comments.

### BRIEF DESCRIPTION

In accordance with one aspect of the exemplary embodiment, a method for determining when to escalate from one support level to a higher support level includes storing information on past users' interactions with a self help server during prior self help sessions, the self help server providing a first remote support level for troubleshooting a problem with a device. Information is stored on a current user's interactions with the self help server during a current self help session for troubleshooting the current user's problem with a device. A determination of when to provide for escalation to a higher remote support level for troubleshooting the current user's problem with the device is based on the stored information on the past users' interactions and the current user's interactions.

In another aspect, a system for determining when to escalate from a first support level to a second support level includes a self help server providing a first remote support level for troubleshooting a user's problem with a device. Memory stores information on a current user's and prior users' interactions with the self help server during self help sessions. A session manager is implemented in hardware and software and is configured to provide for escalation from the first remote support level to a second remote self help level for troubleshooting a current user's problem with a device based on stored information on the past users' interactions and the current user's interactions with the self help server.

In another aspect, a method for determining when to escalate from one support level to a higher support level includes storing information on a current user's interactions with a device during a first level of support. Based on the interactions with the device, the method includes determining when to propose escalation to a second level of support, the second level of support being provided by a self help manager which inputs a user's query to a knowledge base. Information is stored on past users' interactions with the self help manager during prior users' self help sessions. Information is stored on the current user's interactions with the self help manager in a self help session at the second level of support. Based on the stored information on the past users' interactions and the current user's interactions with the self help manager, the method includes determining when to provide for escalation to a third support level which provides communication with a remote operator.

### BRIEF DESCRIPTION OF THE DRAWINGS

FIG. 1 is a schematic diagram illustrating escalation levels in an exemplary troubleshooting operation;

FIG. 2 is functional block diagram of a troubleshooting system in accordance with one aspect of the exemplary embodiment;

FIG. 3 illustrates a method which may be performed with the system of FIG. 2; and

FIG. 4 illustrates an example of distribution of visits to knowledge base cases in troubleshooting sessions.

### DETAILED DESCRIPTION

Aspects of the exemplary embodiment relate to a system and method for flexibly advancing the escalation of customer support through different levels of support, taking into account the customer's experience. The exemplary embodiment can provide a cost effective support for customers of electromechanical devices, such as printers. Different levels of support are provided. One or more levels may involve provision of resources which the customer can use for self-help. This may include providing access to a local or remote resource which proposes solutions to the user. Another resource level may be the provision of remote troubleshooting from a call center where the call center operator may guide the user through steps for solving the problem. Yet another level of support may involve a service engineer visiting the customers' site. These support levels can proceed incrementally, with the user progressing from one level to a higher level, the higher level being an escalation of the first one. The escalation may be triggered by the user, or automatically, when, for example, a lower support level, such as the self-help level, fails to resolve the problem.

As used herein, a “printer” can include any device for rendering an image on print media, such as a copier, laser printer, bookmaking machine, facsimile machine, or a multifunction machine, which includes at least one of these capabilities in addition to one or more other capabilities. In general, such devices render an image on print media, such as paper or other suitable print media substrate, using marking material such as ink(s) or toner(s). The operation of applying images to print media, for example, graphics, text, photographs, etc., is generally referred to herein as printing or marking. While the exemplary embodiment is described in terms of a printer, it is to be appreciated that other electromechanical devices are also contemplated.

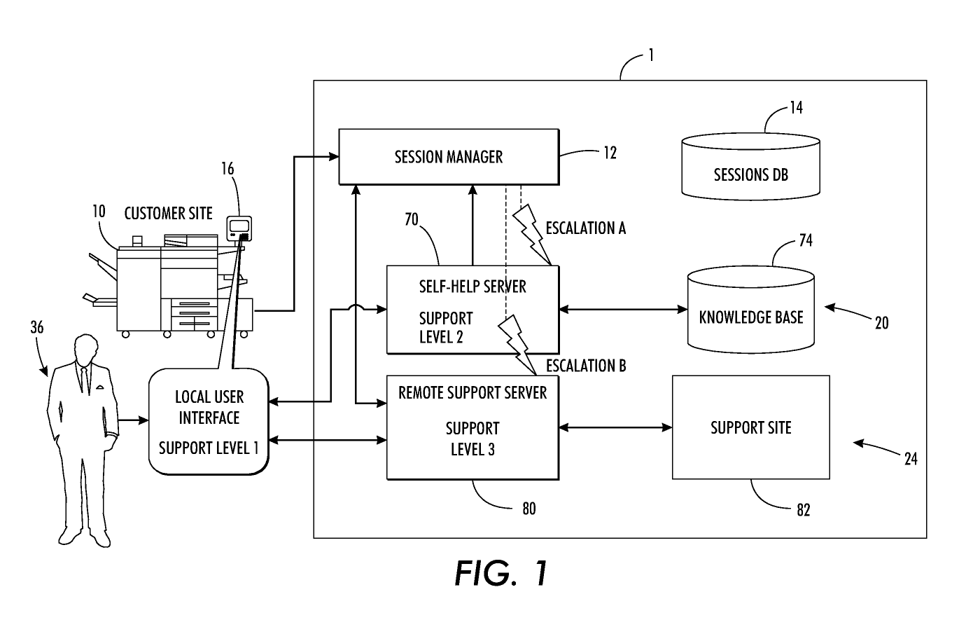

With reference to FIG. 1, a device troubleshooting system 1 is illustrated in the context of a printer environment. The troubleshooting system 1 is accessible from the devices and encapsulates a solution for self-help and remote collaborative support where the escalation to each higher support level is assisted. Escalation levels A and B are illustrated, although it is to be appreciated that there may be fewer or more than two escalation levels. The exemplary system 1 has three support levels which assist a user in resolving a problem with an electromechanical device 10 (which may be referred to herein as “troubleshooting”). The three support levels are labeled support levels 1, 2, and 3, respectively and are associated with different components of the printer environment, as will be described in greater detail below. The first level may be a local support level, performed on the device 10. The second support level is a first remote support level in which a user accesses a knowledge base. The third support level is a second remote support level providing access to a call center operator.

The system 1 is configured for executing a method to establish when the system should escalate from one defined support level to a higher one of the support levels, taking into account records of the customer experience during the troubleshooting activity and records of prior users' experience. In the exemplary embodiment, the decision of when it is appropriate to escalate to a next support level is made by a session manager 12, which may be based on information gathered during a troubleshooting session as well as on prior session information, both of which may be stored in a sessions database 14.

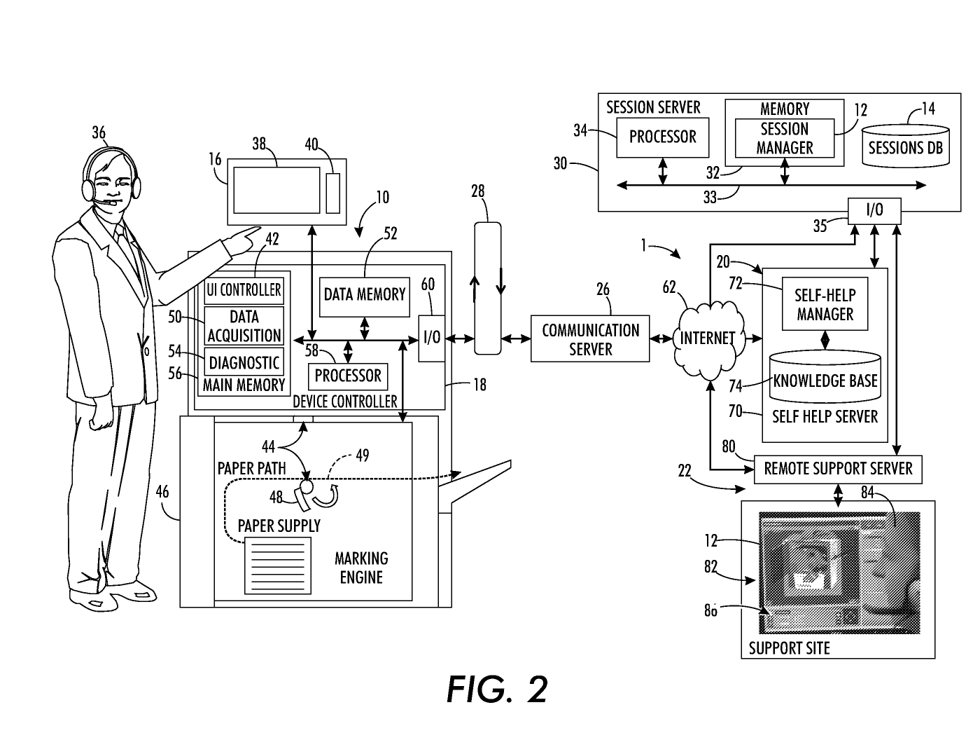

With reference also to FIG. 2, which illustrates one exemplary configuration of the system 1 in a printing environment, one or more printers 10 have a local user interface (UI) 16 mounted on or otherwise associated with the printer 10. A device controller 18 of the printer 10 in cooperation with the UI 16 serves as a first, local support resource to the user. The device controller 18 may be resident on the printer, as shown (e.g., in the digital front end (DFE)), or linked thereto and may include both hardware and software.

Access to second and third levels of support in the form of troubleshooting resources 20, 22 is provided by the system 1. In one embodiment, each printer 10 is in communication with one or more communication servers 26 that collect data from the printers 10 and relay that data to the system 1. Each communication server 26 may communicate with its corresponding printers 10 within a network 28. The network 28 may be in the form of wired or wireless links or other means capable of supplying or communicating electronic data to and/or from the connected/linked elements. For example, the links between elements can be telephone lines, computer cables, ISDN lines, wireless communication links (e.g., employing Bluetooth™ wireless technology), or the like. The network 28 may include, but is not limited to, a local area network (LAN), a wide area network (WAN), the Internet or another communications network, such as a wireless or wired network.

Each of the support resources 18, 20, 22 is in communication with a session server 30, which hosts the session manager 12 and sessions database 14. In the exemplary embodiment, the session manager 12 is implemented in hardware and software, the software being stored in memory 32, which may also store the sessions database 14. The software is executed by an associated processor 34. The session server 30 can comprise any suitable computing device and may be linked, directly or indirectly, to the network 28 through an input/output device 35. Components 32, 34, 35, and 14 are linked by a data control bus 33.

In the first level of support (local support level), a user 36 facing a problem with the device may follow directions on the user interface 16 and interact with the device 10 to try and solve a problem. The problem may be due to a device fault, a need for replacement of consumables, such as toner, or because the user does not know how to perform a particular action on the device, such as double-sided printing. The user interface 16 includes a display 38 and a user input device 40, such as a keypad, touch screen or the like. The user interface communicates with a user interface controller 42, which may be hosted by the device controller 18. Sensors 44 on the device detect actions of the user, such as opening doors 46, moving levers 48 to gain access to the paper path 49 for removing paper jams, other repair operations, and the like. A data acquisition component 50 collects the data received by the various sensors 44 and from the user interactions with the user interface 16 and stores the information in data memory 52. A diagnostic component 54 processes the information from the sensors 44 and other components of the printer 10 to determine a status of the printer 10. When the status relates to a problem, the device controller provides the user 36 with information on the user interface 16 for resolving detected user-correctable problems. In this local self-help stage, this may include displaying text and/or graphics identifying a problem and what the user can do to try to resolve it, such as moving levers to access the paper path, replacing consumable items, and the like.

As illustrated in FIG. 2, the components 42, 50, 54 of the device controller 18 may include software instructions stored in main memory 56, which are executed by an associated processor 58. The processor 58, such as a CPU, may also control the overall operation of the printer.

The device controller 18 includes a network interface 60 which enables the device 10 to communicate with the network 28. The communication server 26 thus links the device controller 18 with the session server 30, e.g., via a local area network or wide area network, such as the Internet 62.

As will be appreciated, FIG. 2 provides only a simplified view of the device controller 18 and sensors 44. Further details on diagnostic systems which may be used herein are disclosed, for example, in U.S. Pub. No. 2008/0126860, published May 29, 2008, entitled FAULT MANAGEMENT FOR A PRINTING SYSTEM, by Meera Sampath, et al., and the references cited therein, the disclosures of which are incorporated herein by reference in their entireties.

In one embodiment, the session manager 12 monitors the user actions on the operable parts of the device 10 that are equipped with sensors 44, the status code of the device, and the actions on the local UI 16. Operational history data is provided by the data acquisition and/or diagnostic components 50, 54 within the printer 10, which may be sent automatically at intervals or upon receiving a request from the system 1. In one embodiment, information sent to the session manager 12 may include information only related to those interactions which are predominantly associated with maintenance or faults and not with normal operations on the printer.

Based on the information received, the session manager 12 determines when the user 36 is having a problem with the device 10 that the user is unable to correct. For example, the session manager 12 may detect that the user is having a problem because the user presses a button repeatedly without printing a job or performs some other action on the device not associated with normal operation of the device. The session manager analyses the data received from the printer 10 to extract information associated with a single user session in order to identify the duration of the session. Each session corresponds to a series of user's interactions. The time between actions on a device can be used to distinguish one session from a prior user session. In one embodiment, based on the history of durations of prior user sessions stored in the KB 14, the session manager 12 is able to predict when the user is likely to give up and offer the self help session at a suitable time, e.g., before the user is likely to give up but not so soon as to annoy the user.

When the session manager 12 determines that the user is unable to solve the problem in the local support session, the session manager triggers the provision of the second level resource 20. For example, a popup or other message appears on the local UI 16 of the device 10 to ask the user if he wants to engage in a self-help session with the remote resource 20. If the user accepts, this automatically initiates escalation to the first remote support level, which starts a remote self help session.

In the exemplary embodiment, the remote self help resource 20 is hosted by a self-help server 70, which can be the same or a separate computer from the session server 30, and like the session server, include hardware and software for implementing the first remote support level. The remote self help server 70 provides a second level of support to the user, based on data communicated from the printer 10, by providing access to troubleshooting information. The data communicated to the self help server 70 may include user queries input through the user interface 16 as well as diagnostic and operational history information from the device controller 18. In the exemplary embodiment, the self help server 70 hosts a remote self-help manager 72, which has access to a knowledge base (KB) 74 stored in memory, which may be located on the server 70 or accessible thereto. The remote help manager 72 may include software stored in memory executed by a computer processor, such as the server 70's CPU (not shown).

In the case of printers, the KB 74 includes an indexed set of cases which relate to known problems with a printer on the network 28. Each case may include a problem statement, which describes a known problem that can occur on the printer 10, and one or more solutions. Each solution includes a sequence of steps which a user can perform on a malfunctioning printer 10 to correct the problem. Since a particular observed problem can have several solutions, depending on the underlying cause of the observed problem, the solutions are presented to the user in a ranked order, often with the solutions that are easiest to perform listed first. The remote help manager 72 receives a user query and, based on the user query, conducts a search of the knowledge base 74 to retrieve responsive cases. Device information, e.g., acquired by the session manager 12, may also be used by the remote help manager 72, for example, in ranking the cases. Systems for developing user queries for conducting a search of such a knowledge base 74 are disclosed, for example, in U.S. Pub. Nos. 2007/0192085; 2007/0220365; 2008/0091408; 2008/0294423; 2009/0106224; and 2009/0292700, the disclosures of which are incorporated herein in their entireties by reference. The solutions are communicated from the self help server 70 to the device controller 18, which causes them to be displayed on the user interface 16.

A user 36 may attempt one or more of the solutions proposed by the self help server 70. Data collected related to these attempts (such as how many queries the user entered, which solutions the user reviewed, which detectable actions the user undertook on the device 10, and whether or not the session was successful), is acquired by the session manager 12. This information is stored in the sessions database 14. Information extracted from the sessions database is used by the session manager 12 to identify when to propose escalating to the next level to the user, i.e., the third level of support.

For the third level resource 24, the printers 10 and/or their human operators 36, are able to communicate with a remote support server 80 which provides access to the third level of support (second remote support level). The remote support server 80 enables a user 36 of the device to engage in a live conversation with a remote expert. In particular, the remote support server 80 is linked to a remote call center 82 by a wired or wireless link. The communication between the user and an expert 84 may be text communication via the user interface 16, voice communication, facsimile, electronic mail or messaging, or other communication by which a device operator 36 may request service from the call center 82. The call center 82 may include a group of experts 84 who can communicate with printer users 36 to attempt to resolve a service issue by telephone, electronic mail or messaging, or another communications mechanism. The expert 84 may review a graphical representation of the device 10 on a display 86, while the same graphical representation is contemporaneously displayed to the user on the local UI 16. Information on the self help session (first remote support level) may be provided to the call center operator 84 by the session manager 12 or self help server 70 so that he is aware of which solutions have already been reviewed/attempted. If the call center operator 84 is unable to resolve an issue, he may initiate a request to send a customer service representative such as an engineer or technician, to the printer location for on-site service.

Both the self help server 70 and remote support server 80 are in communication with a session server 30.

Each of the illustrated support servers 70, 80 may include any suitable computing device with memory and an associated computer processor configured for executing instructions stored in the memory as software for implementing the operations of these components as described herein. Although the servers 30, 70, 80 are shown as separate components, two or more of them may alternatively be combined.

As discussed above, the exemplary session manager 12 supports the escalation toward the higher levels of support. In particular, it directs the customer 36 to self help resources 20 (second level) when a difficulty is first detected. It assists the customer in switching to the third level of assistance 24 when the probability of success (level of confidence) with self-help is predicted to be too low. It also enables the third level resource 24 to benefit from what was done at the second level, to avoid redundant operations at the third level. In particular, the session manager 12 collects information on relevant interactions of the user 36 with the device 10 and with the self help server 70. The information on the user interactions with the device (e.g., opening a door on the device, moving levers, opening drawers, removing consumables, such as toner containers, etc) as well as status information of the device provided by sensors 44, are synchronously sent to the session manager 12 by the device controller 18. The information on the user interactions with the KB 74 (e.g., entering a natural language query) is sent by the self help server 70 to the session server and stored in sessions database 14 for processing by the session manager 12. The session manager 12 analyzes the data collected and is responsible for automatically triggering the escalation to the self help service or to the remote support service when certain threshold conditions are met.

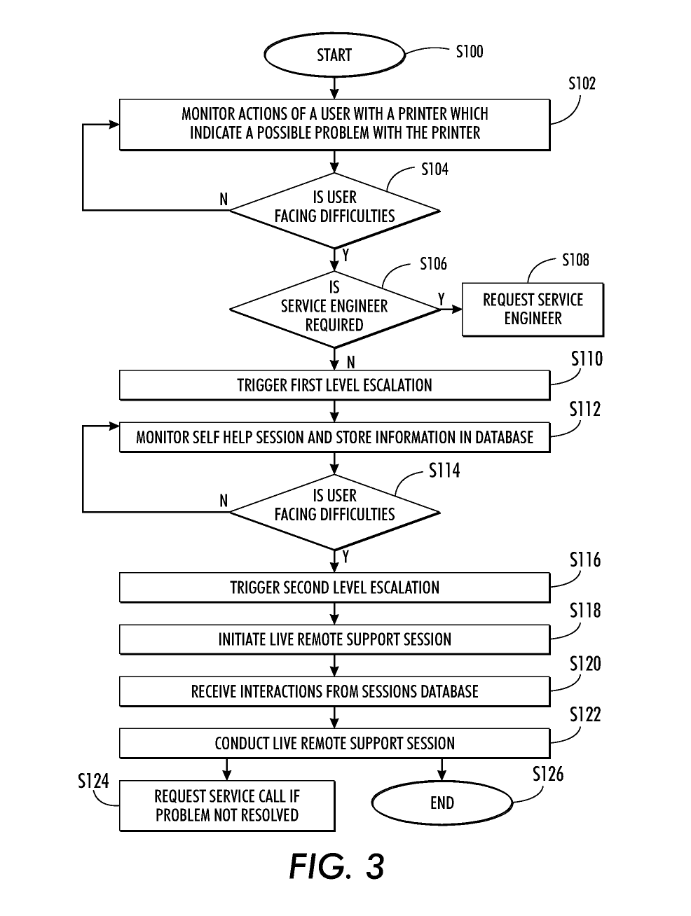

The memory 52, 56, 32 of the device 10 and servers 30, 70, 80 may represent any type of tangible computer readable medium such as random access memory (RAM), read only memory (ROM), magnetic disk or tape, optical disk, flash memory, or holographic memory. In one embodiment, the memory comprises a combination of random access memory and read only memory. The digital processors 58, 34 of the device 10 and servers 30, 70, 80 can be variously embodied, such as by a single-core processor, a dual-core processor (or more generally by a multiple-core processor), a digital processor and cooperating math coprocessor, a digital controller, or the like. The digital processors, separately or in combination, in addition to controlling the operation of the device and respective servers, execute instructions stored in memory for performing the method outlined in FIG. 3.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 3 illustrates an exemplary method for managing the escalation process.

The method begins at S100.

At S102, actions of a user with the printer 10 which indicate a possible problem with the printer are detected by the printer. At this stage, the user is interacting solely with the printer 10 and has not sought remote assistance from the self help server or remote support server. The session manager 12 monitors the actions on the operable parts of the device 10 that are equipped with sensors, the status code of the device, and the actions on the local UI.

In one embodiment, all user actions are monitored. In other embodiments, triggering actions begin monitoring. The communication server 26 may periodically execute commands to collect operational history data from its corresponding printers 10 by polling the printers 10 and forward the data to the session server 30 upon request of the session server, or automatically. Alternatively, the printers 10 may push operational history data to the communication server 26 in a manner that is continuous, periodic, or responsive to one or more actions at the printer 10. Examples of operational data that a printer 10 may transmit to the session server 30 in this way may include status information, one or more fault codes that indicate an actual or potential maintenance requirement for the printer, user interactions with the printer detected by the sensors 44, such as opening of doors, user interactions with the local user interface 16, a configuration reflecting individual components that are included as part of the printer, a software type and version for the device 10 or its individual components, a time of the last status check, a machine running time, an indication of whether routine maintenance is due for a consumable component, a measurement of time or usage since an individual component (such as a photoreceptor, toner cartridge, pressure roll, or other component) was last installed, cleaned or otherwise serviced, a measurement of toner weight, and the like.

At S104, the session manager 12, based on an analysis of the data provided by the printer 10, assesses whether the user is facing difficulties. This analysis is generally made before the user requests remote assistance, i.e., based solely on the information received.

At S106, when at least one threshold condition is met to suggest that the user is having trouble, the session manager 12 checks to see if the printer is detected to be in a failure status that requires a service engineer intervention. If so, at S108 the session manager 12, or the printer controller 18, generates a message which is displayed on the user interface 16 to alert the user that the printer problem will require a service engineer visit and may automatically request one.

If at S106, no such failure state is detected, then at S110, the session manager triggers a first level of escalation A involving the self-help server 70. For example, a popup or message appears on the local UI 16 of the device to ask the user if he or she wants to engage in a self-help session. If the user accepts, this starts the self help session.

At S112, while the user is engaged in a self-help session, the interactions with the self-help server 70 are monitored by the session manager 12 and stored in the associated database 14.

At S114, the session manager 12 assesses whether the state of the self help session suggests that the user is experiencing some difficulties in order to find the appropriate solution to his or her problem. If so, a second level of escalation B is initiated.

At S116, the session manager triggers the remote support server 80. For example, a message or popup appears on the local UI 16 of the device to propose to the user to start a live remote support session with an expert.

At S118, if the user accepts, a call to a call center 82 is issued. An agent from the call centre can then take the call and this establishes a live remote support session with the user 36 of the device 10.

At S120, at the beginning of the remote support session, the remote support server 80 can connect to the session manager 12, retrieve the data comprising the interactions that were monitored during the self-help session at S112 and stored in the sessions database 14, and display them to the call center agent 84. Additional information stored in the first stage may also be made available to the call center operator. This information is a benefit to the agent since the agent is able to have an understanding of what was done already by the user and will avoid wasting time questioning the user about it.

At S122, the user and call center agent engage in a troubleshooting session in which the user and call center agent may view a representation of the printer on their respective screens and the call center agent can guide the user through a sequence of operations intended to cure the problem.

At S124, if the dialog and actions taken by the user are unable to resolve the problem, the call center operator enters a request for a service call.

The method ends at S126.

The method illustrated in FIG. 3 may be implemented in a computer program product that may be executed on a computer (or a set of computers). The computer program product may be a computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method for adaptive escalation of a troubleshooting session.

Having described in the overall process for an adaptive escalation of support resources, further details of the system and method will now be described.

### Determination of What Constitutes a Session

For detecting the need to trigger a self help escalation from one level to the next, a time frame for what constitutes a session is determined so that a set of events can be associated with a particular session. In the case of the first level, sequences of close events on the device that can be linked to a repair operation can be used to define the time period of a user session. Events linked to a repair operation are sometimes difficult to distinguish from normal operations a user may perform on the device, such as replacing paper, etc. Methods have been developed for distinguishing sequences of actions related to a repair from normal sequences by comparing them with known repair sequences. See, for example, above-mentioned U.S. Pub. No. 2007/0220365, the disclosure of which is incorporated herein by reference. For example, the session manager compares the detected actions which have been performed on the printer over the course of, for example, a day and finds a sequence of events which are close together in time and which show at least some similarity with a known repair sequence (allowing for the fact that a user may not always follow repair instructions correctly) and/or which involve actions which are associated with repairs but rarely performed in normal operation of the device.

The duration of the session for the second level is readily determined from the time the user first inputs a query which is used to search the knowledge base 74.

### Escalation Trigger Criteria

Each escalation decision is triggered by one or more parameters. In the exemplary embodiment, the session manager 12 monitors a combination of parameters which alone or in combination can trigger an escalation. For example, a trigger for escalation will be fired as soon as a single one (or, in some embodiments, both) of the two following conditions are met:

Condition 1. The computed level of confidence that the user will persevere in the troubleshooting activity is too low. This can be computed as a function of when one or a combination of the monitored parameters of a session has dropped below a first threshold.

Condition 2. The customer's last interaction combined with the current session status suggests strongly that the session is not currently leading to success, i.e., indicates this is probably an interaction that is more associated with a backtrack step than a conclusion step. Thus, a computed level of confidence that the current self help session is not leading to success is above a second threshold.

For determining whether Condition 1 is satisfied, relevant parameters are those of the session's observable variables that are strongly associated with a cost for the user.

In the case of the first level, where a user attempts to solve the problem using his own knowledge or with instructions displayed on the printer, one or more of the following parameters can be monitored within a session:

1. Overall duration of the session.

2. Total number of user actions.

3. Number of repeated user actions.

In the case of the self-help level, when detecting the need to trigger a remote support session with an expert, both the events from the self-help server 70 and from the device 10 which occurred during the time of the self-help session can be considered. For example, one or more of the following parameters can be monitored and used to compute the level of confidence:
1. Overall duration of the self help session.
2. Number of searches conducted in the KB 74.
3. Number of cases and/or solution pages visited by the user in the KB (each solution can be considered as a separate page, which when opened by the user, is detected by the system 1. Similarly the system detects each case as a whole which is viewed, where a given case may include one or more solution pages).
4. Duration of the application of a set of instructions detailed on the currently displayed solution page of the KB 74 (each solution may be associated with a threshold time which is deducted from the elapsed time to account for the time normally expected to be required for the user to implement the steps of the solution)
5. Number of detectable operations on the device 10 performed by the user during the time when a solution page of the KB is displayed.

For determining whether Condition 2 is met, the following parameters may be considered and used to compute the level of confidence:
A. When detecting the need to trigger self-help, any operation performed by the user on the device 10 that does not turn back the device to its normal functioning state.
B. When detecting the need to trigger a remote support session with an expert, the following interactions can be considered:
   1. Any operation performed by the user on the device that does not turn back the device to its normal state of functioning that occurs when a solution of the KB 74 is being displayed.
   2. The start of a new search in the KB.
   3. The selection of a new case of the KB after having visited at least one other one.

### Thresholds Settings

The thresholds for each of the parameters can be defined in two ways:

A: They can be computed from an analysis of previous sessions' records in database 14, e.g., by determining at what point did each user in the past, for a population of prior users, give up on the session. For example, a cumulative distribution of each parameter of a set of monitored parameters over the sessions is computed. From this distribution, a value x is identified that corresponds to a cumulated population F(x)>f. f is a parameter of the system which is set with respect to how quickly the session manager 12 should escalate to the next level. This value can be set by an administrator to a value, for example, between 0.2 and 0.8, such that escalation is predicted to take place before at least a percentage of the prior users population would have given up. For example, if f=0.5 for the session duration, the duration corresponding to the time where 50% of the users had already stopped in the past is taken.

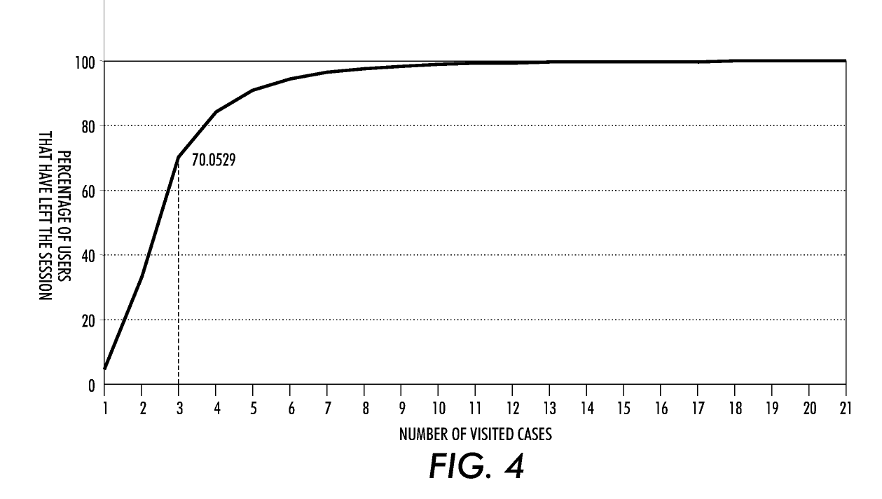

For example, FIG. 4 shows the number of KB cases that were visited in troubleshooting sessions (taken from actual logs). The plot does not distinguish between users who left the session because the problem was resolved and users who left without resolving the problem. It can be seen that 40% of users left the session after having visited at most 2 cases and 70% of users left the session after at most 3 cases. In this case, the threshold will be reached after 3 cases are visited if the administrator of the system has set f=0.5 for this parameter.

B. Another way to establish the thresholds is to have them linked to the current context of the session. This is particularly well adapted for parameters that monitor time or actions performed when a particular solution of the KB 74 is displayed to the user. In this particular case the thresholds, are associated with the specific solution, e.g., a maximum estimated time to complete the solution, a maximum number of operations allowed. These parameters may be documented in the solution itself and retrieved by the session manager 12.

As will be appreciated, thresholds may be established which are a function of two or more parameters. Alternatively or additionally, escalation may be triggered by any one of a set of thresholds being met.

While the system has been described in terms of a printing system, it is also applicable to other networked devices, such as cash distributors (ATMs)

The system and method provide higher customer satisfaction and more rational access to customer services (call centers).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for determining when to escalate from one support level to a higher support level comprising:
storing information on past users' interactions with a self help server during prior self help sessions, the self help server providing a first remote support level for troubleshooting a problem with a device;
storing information on a current user's interactions with the self help server during a current self help session for troubleshooting the current user's problem with a device; and
determining when to provide for escalation to a higher remote support level for troubleshooting the current user's problem with the device based on the stored information on the past users' interactions and the current user's interactions.

2. The method of claim 1, wherein determination of when to provide for escalation is performed by a computer processor.

3. The method of claim 1, wherein the determining when to provide for escalation includes determining whether at least one of the following conditions is met:
a computed level of confidence that the current user will persevere in the self help session is below a first threshold, and
a computed level of confidence that the current self help session is not leading to success is above a second threshold.

4. The method of claim 3, wherein the determining whether at least one of the conditions is met includes determining whether both conditions are met.

5. The method of claim 3, wherein computation of whether the current user will persevere in the self help session is below a first threshold comprises:
monitoring parameters within the current self help session and computing an overall current value based on the monitored parameters, the parameters being selected from:
an overall duration of the current self help session;
a total number of searches conducted in a knowledge base during the current self help session;
a total number of cases or solution pages visited by the user in the knowledge base during the current self help session;
a duration of the application by the current user of a set of instructions detailed on a currently displayed solution page of the knowledge base; and
a number of operations on the device performed during the time when a solution page of the knowledge base is displayed.

6. The method of claim 5, further comprising comparing the current value with stored values recorded in prior sessions.

7. The method of claim 3, wherein the computed level of confidence that the current self help session is not leading to success is based on detecting at least one of:
an operation performed by the user on the device that does not turn back the device to its normal state of functioning that occurs when a solution of a knowledge base is being displayed;
a start of a new search in the knowledge base by the user; and
a selection by the user of a new case of the knowledge base after having visited at least a predetermined number of other cases.

8. The method of claim 1, wherein each remote self help session includes searching a knowledge base based on a user's query and retrieving, where present in the knowledge base, at least one solution for a user to perform.

9. The method of claim 8, wherein the stored interactions include the solutions reviewed by the user.

10. The method of claim 1, wherein the stored information further comprises stored interactions with the device during the self help session.

11. The method of claim 9, wherein the determining when to provide for escalation to the higher remote support level is based on the stored interactions with the device during the self help session.

12. The method of claim 1, wherein the higher support level is provided by a operator in communication with the current user.

13. The method of claim 1, wherein the providing for the escalation includes suggesting escalation to the user via a user interface, and, if the user requests the escalation, automatically initiating the escalation to the higher remote support level.

14. The method of claim 1, further comprising providing for information on the current user's interactions during the lower support level to be accessed at the higher remote support level.

15. The method of claim 1, wherein the method further comprises provision for escalation from a local support level provided by the device to the first remote support level based on stored information on the current users' interactions with the device during a local self help session.

16. The method of claim 16, wherein the provision for escalation to the first remote support level includes determining whether at least one of the following conditions is met:
a computed level of confidence that the current user will persevere in the local self help session on the device is below a first threshold, and
a computed level of confidence that the current local self help session is not leading to success is above a second threshold.

17. The method of claim 1, wherein the device comprises a printer.

18. A computer program product encoding instructions, which when executed on a computer causes the computer to perform the method of claim 1.

19. A system for determining when to escalate from a first support level to a second support level comprising:
a self help server providing a first remote support level for troubleshooting a user's problem with a device;
memory which stores information on a current user's and prior users' interactions with the self help server during self help sessions,
a session manager implemented in hardware and software which is configured to provide for escalation from the first remote support level to a second remote self help level for troubleshooting a current user's problem with a device based on stored information on the past users' interactions and the current user's interactions with the self help server.

20. The system of claim 19, wherein the session manager determines when to escalate from the first remote support level to the second remote support level, based on whether at least one of the following conditions is met:
a computed level of confidence that the current user will persevere in the self help session is below a first threshold, and
a computed level of confidence that the current self help session is not leading to success is above a second threshold.

21. The system of claim 19, wherein the session manager determines when to escalate from a local support level to the first remote support level based on whether at least one of the following conditions is met:
a computed level of confidence that the current user will persevere in the self help session is below a first threshold, and
a computed level of confidence that the current self help session is not leading to success is above a second threshold.

22. A method for determining when to escalate from one support level to a higher support level comprising:
storing information on a current user's interactions with a device during a first level of support;
based on the interactions with the device, determining when to propose escalation to a second level of support, the second level of support being provided by a self help manager which inputs a user's query to a knowledge base;
storing information on past users' interactions with the self help manager during prior users' self help sessions;
storing information on the current user's interactions with the self help manager in a self help session at the second level of support; and
based on the stored information on the past users' interactions and the current user's interactions with the self help manager, determining when to provide for escalation to a third support level which provides communication with a remote operator.
